(19) United States
(12) Patent Application Publication
(10) Pub. No.: US 2014/0253380 A1
(43) Pub. Date: Sep. 11, 2014

(54) ACTIVE RETRODIRECTIVE WIRELESS COMMUNICATION APPARATUS

(71) Applicant: Electronics and Telecommunications Research Institute, Daejeon-si (KR)

(72) Inventor: Jung-Pil CHOI, Daejeon-si (KR)

(73) Assignee: Electronics and Telecommunications Research Institute, Daejeon-si (KR)

(21) Appl. No.: 14/097,973

(22) Filed: Dec. 5, 2013

(30) Foreign Application Priority Data
Mar. 6, 2013 (KR) 10-2013-0024178

(51) Int. Cl. H04B 7/02

(52) U.S. Cl. CPC H04B 7/02
USPC 342/367

(57) ABSTRACT

An active retrodirective wireless communication apparatus is provided. The active retrodirective wireless communication apparatus can extend a communication range by enabling communication with a wide area user who is not able to communicate via an omnidirectional antenna, by alternately operating a plurality of active retrodirective antennas during a time interval for performing omnidirectional communication among a plurality of local area users, and a time interval for performing directional communication to a specific wide area user.

### CROSS-REFERENCE TO RELATED APPLICATION

This application claims the benefit under 35 U.S.C. §119(a) of Korean Patent Application No. 10-2013-0024178, filed on Mar. 6, 2013, the entire disclosure of which is incorporated herein by reference for all purposes.

### BACKGROUND

1. Field

The following description relates to retrodirective antenna operating technology, and more particularly, to an active retrodirective wireless communication apparatus.

2. Description of the Related Art

A retrodirective antenna disclosed in Korean Publication No. 10-2007-0003768, published Jan. 5, 2007, is an antenna system which reflects radio waves incident in a certain direction without advance information in the same direction, and has a radiant characteristic of an entirely different concept from a conventional reflection plate obeying Snell's law which states that the ratio of the angle of incidence to the angle of reflection is constant.

The retrodirective characteristic may be implemented by a phase-conjugate array. Due to its specific reflection characteristic, it is applicable to a remote wireless sensor, an RFID tag, a transponder for identification and for rescue, an access point of a wireless LAN, a road side base station of an intelligent vehicle highway (IVHS) system, a vehicle identification apparatus of a toll gate, etc. As the importance of beam tracking in a next-generation mobile communication system has increased, application of the retrodirective characteristic to a smart antenna for a base station has been actively studied.

### SUMMARY

The following description relates to an active retrodirective wireless communication apparatus which can extend a communication area by enabling communication with a wide area user who is not able to communicate via an omnidirectional antenna, by rationing a time interval for performing omnidirectional communication among a plurality of proximate users, and a time interval for performing directional communication to a specific wide area user.

In one general aspect, an active retrodirective wireless communication apparatus includes: an antenna group configured to include a plurality of retrodirective antennas arranged in a radial form, each of the plurality of retrodirective antennas having a specified azimuth and elevation; an antenna switch configured to selectively switch at least two retrodirective antennas, which are arranged in a radial form, among the plurality of retrodirective antennas included in the antenna group during local area omnidirectional communication, and selectively switch one specific retrodirective antenna among the plurality of the retrodirective antennas included in the antenna group during wide area directional communication; and an antenna selecting portion configured to determine whether a communication mode is a local area omnidirectional communication mode or a wide area directional communication mode, select one or more retrodirective antennas according to the determined communication mode, and transmit an antenna switching command instructing the selected one or more retrodirective antennas to switch to the antenna switch.

In another general aspect, the apparatus may further include: a communication mode setting portion configured to set the communication mode to the local area omnidirectional communication mode or the wide area directional communication mode.

The communication mode setting portion may set the communication mode to the local area omnidirectional communication mode during a first time interval, and to the wide area directional communication mode during a second time interval.

The first time interval and the second time interval may repeatedly alternate.

In still another general aspect, the apparatus may further include: a user detecting portion, in the wide area directional communication mode, configured to detect a wide area directional communication user for each of the plurality of the retrodirective antennas.

The antenna selecting portion, in the wide area directional communication mode, may select the retrodirective antenna for which the wide area directional communication user is detected by the user detecting portion.

In still another general aspect, the apparatus may further include: an RSS measuring portion configured to measure a received signal strength (RSS) of an RF signal which is incident upon each of the plurality of the retrodirective antennas; and an SNR measuring portion configured to measure a signal-to-noise ratio (SNR) of the received RF signal.

The antenna selecting portion, in the local area omnidirectional communication mode, may consider the received signal strength (RSS) of the RF signal which is incident upon each of the plurality of the retrodirective antennas measured by the RSS measuring portion, and the signal-to-noise ratio of the RF signal measured by the SNR measuring portion, and select at least two retrodirective antennas.

In still another general aspect, the apparatus may further include: a phase-conjugate shifting portion configured to phase-shift by 180 degrees and reradiate the phase of RF signal which is incident upon each of the plurality of the retrodirective antennas, and align a reflected wave main lobe with a direction of incidence.

In still another general aspect, the apparatus may further include: a transmitting and receiving portion configured to transmit the RF signal to the phase-conjugate shifting portion and to receive the RF signal form the phase-conjugate shifting portion.

These and other features and advantages of the present invention will be made apparent in the following detailed description, the drawings, and the appended claims.

### BRIEF DESCRIPTION OF THE DRAWINGS

FIG. 1 is a diagram explaining an operation principle of a retrodirective antenna system using a phase-conjugate array.

FIG. 2 is a block diagram showing an active retrodirective wireless communication apparatus according to an embodiment of the inventive concept.

FIG. 3 is a diagram showing a retrodirective antenna array in which two retrodirective antennas are included in an antenna group according to an embodiment of the inventive concept.

FIG. 4 is a diagram showing a retrodirective antenna array in which three retrodirective antennas are included in an antenna group according to an embodiment of the inventive concept.

FIG. 5 is a diagram showing a retrodirective antenna array in which eight retrodirective antennas are included in an antenna group according to an embodiment of the inventive concept.

FIG. 6 is a diagram showing a correlation between number of selected retrodirective antennas and communication area according to an embodiment of the inventive concept.

FIGS. 7a to 7d are diagrams explaining a case in which a communication time interval is divided into a local area omnidirectional communication interval and a wide area directional communication interval according to an embodiment of the inventive concept.

FIG. 8 is a diagram explaining a case in which a communication signal is broadcast to a plurality of local area users using every retrodirective antenna according to an embodiment of the inventive concept.

FIG. 9 is a diagram explaining a case in which broadcasts a communication signal to a specific wide area user using one specific retrodirective antenna according to an embodiment of the inventive concept.

FIG. 10 is a flowchart showing a communication operation of an active retrodirective wireless communication apparatus according to an embodiment of the inventive concept.

Throughout the drawings and the detailed description, unless otherwise described, the same drawing reference numerals will be understood to refer to the same respective elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Various changes, modifications, and equivalents of the methods, apparatuses, and/or systems described herein will suggest themselves to those of ordinary skill in the art. Also, descriptions of well-known functions and constructions may be omitted for increased clarity and conciseness.

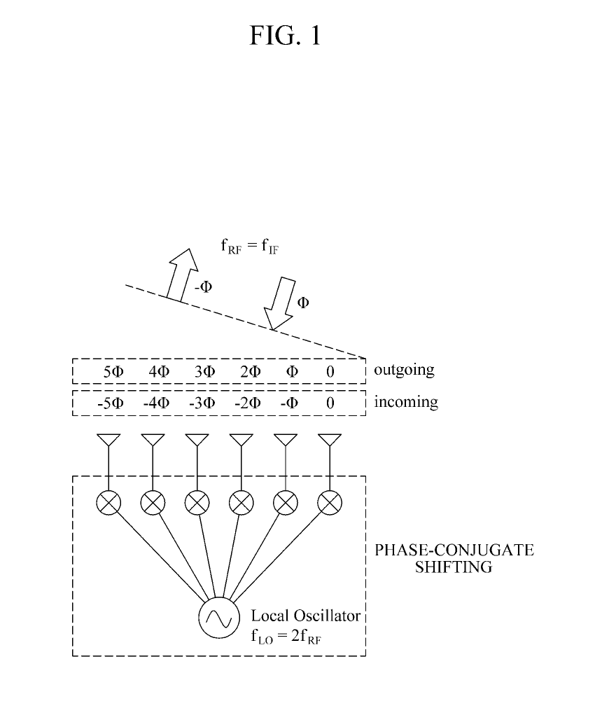

FIG. 1 is a diagram explaining an operation principle of a retrodirective antenna system employing phase-conjugate shifting. A signal input to each retrodirective antenna may be represented as follows.

V_{RF}COS(2πf_{RF}t+Φₙ)

A phase-conjugate shifting output where a frequency set by a local oscillator (LO) is set to twice an RF signal frequency may be represented as follows.

$$\begin{matrix}{V}_{IF} = {V}_{RF} cos ( 2 π {f}_{RF} t + {Φ}_{n} ) \cdot {V}_{LO} cos ( 2 π {f}_{LO} t ) \\ = \frac{{V}_{RF} {V}_{LO}}{2} cos ( 2 π {f}_{IF} t - {Φ}_{n} )\end{matrix}$$

According to the above equations, using phase-conjugate shifting, a transmission beam direction of an antenna may be actively controlled in the same direction as a direction of incidence.

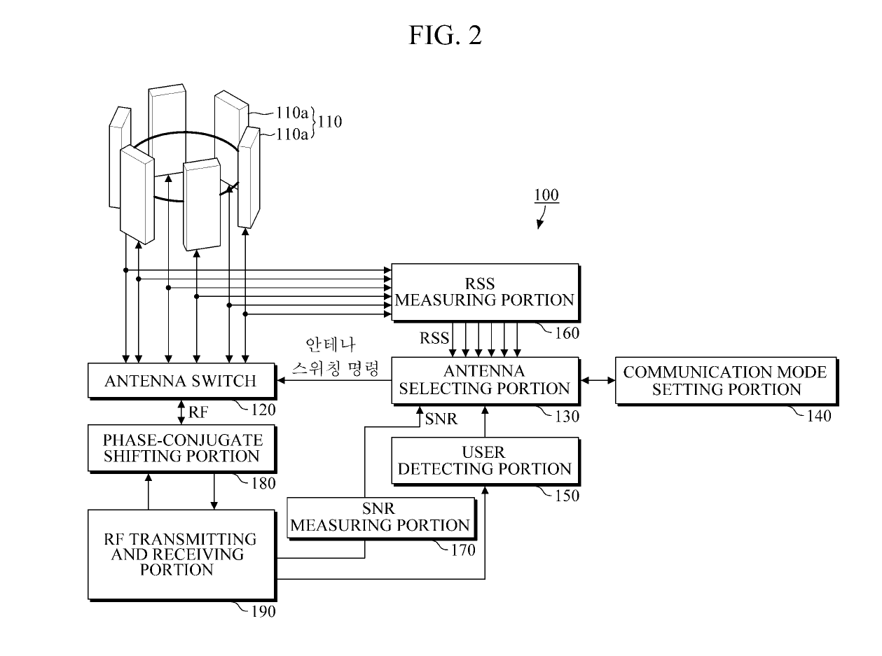

FIG. 2 is a block diagram showing an active retrodirective wireless communication apparatus according to an embodiment of the inventive concept. As shown in FIG. 2, the active retrodirective wireless communication apparatus 100 may include an antenna group 110, an antenna switch 120, and an antenna selecting portion 130.

The antenna group 110 may include a plurality of retrodirective antennas 110a which may be arranged in a radial form, each having a certain azimuth and elevation.

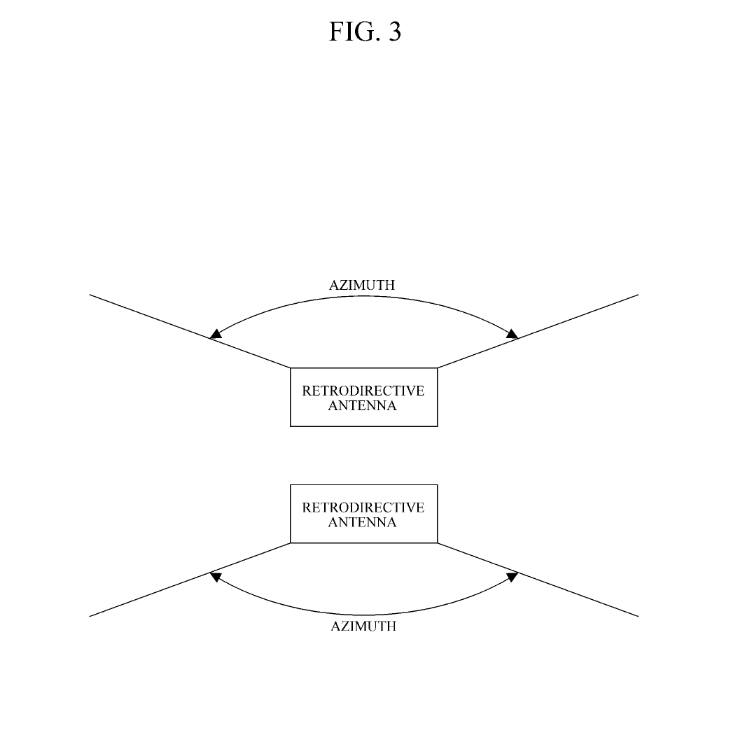

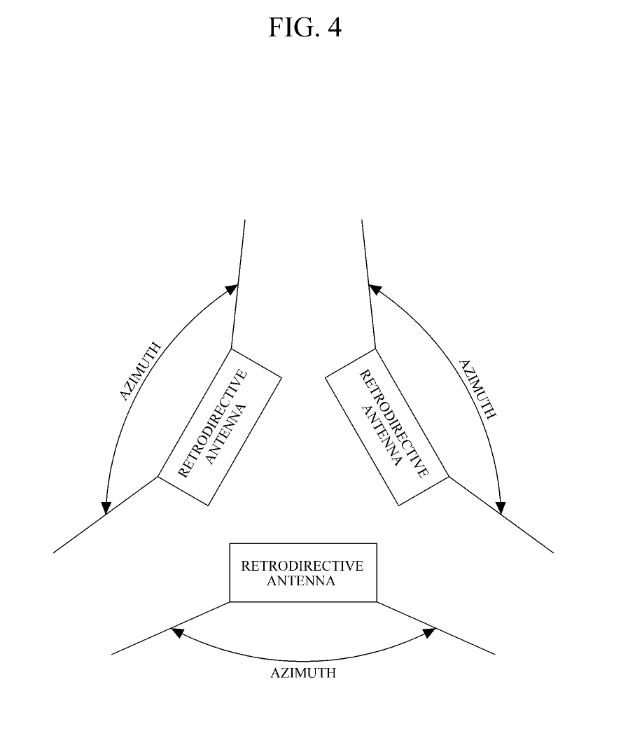

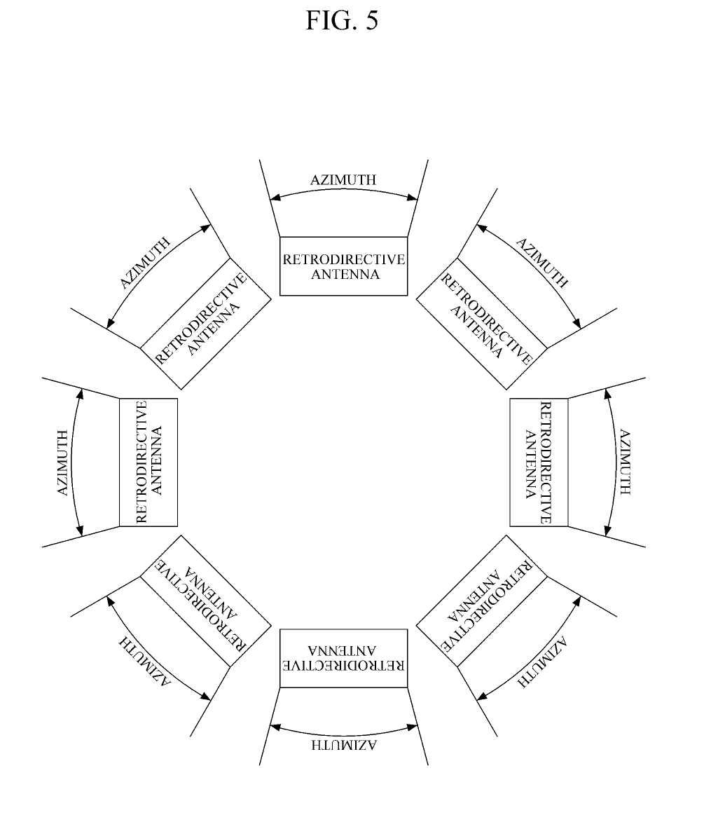

FIG. 3 is a diagram showing a retrodirective antenna array in which two retrodirective antennas are included in an antenna group according to an embodiment of the inventive concept. FIG. 4 is a diagram showing a retrodirective antenna array in which three retrodirective antennas are included in an antenna group according to an embodiment of the inventive concept. FIG. 5 a diagram showing a retrodirective antenna array in which eight retrodirective antennas are included in an antenna group according to an embodiment of the inventive concept.

The antenna switch 120 may selectively switch at least two retrodirective antennas, which are arranged in a radial form, among the plurality of the retrodirective antennas 110a included in the antenna group 110 during local area omnidirectional communication, and selectively switch one specific retrodirective antenna among the plurality of the retrodirective antennas 110a included in the antenna group 110 during wide area directional communication.

The antenna selecting portion 130 may determine a local area omnidirectional communication mode or wide area directional communication mode to select one or more retrodirective antennas among the plurality of the retrodirective antennas 110a included in the antenna group 110, and transmit an antenna switching command indicating that the one or more selected retrodirective antennas are to be selected to the antenna switch 120.

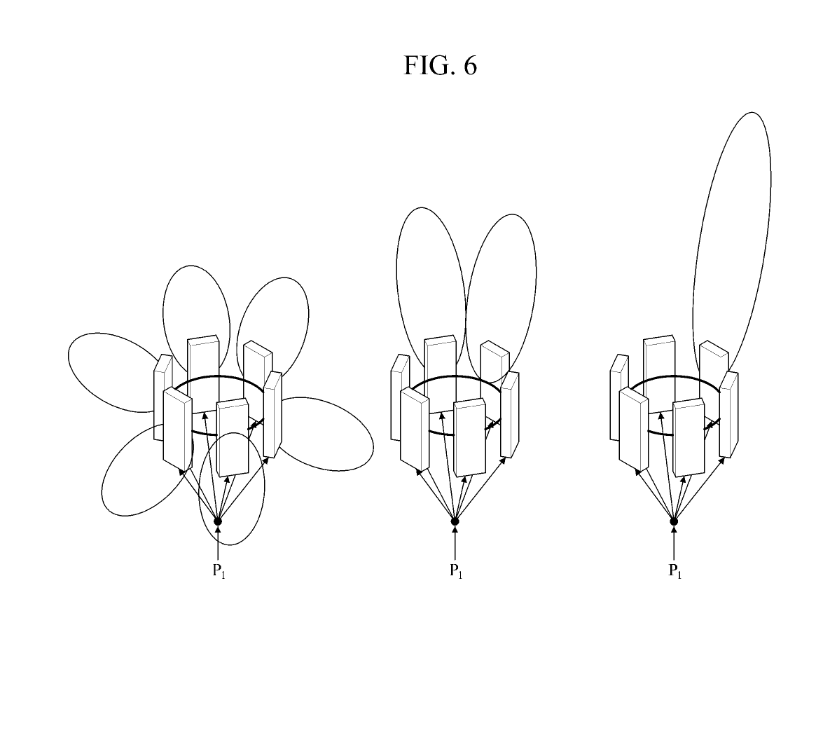

FIG. 6 is a diagram showing a correlation between number of selected retrodirective antennas and communication area according to an embodiment of the inventive concept. As shown in FIG. 6, in using the plurality of the retrodirective antennas, it may be a general feature that, for the same given RF transmission power, the use of one or some of the retrodirective antennas can obtain a higher reception power in a certain predetermined direction than the use of omnidirectional radio waves and every retrodirective antenna.

That is, in a system in which RF signal transmission power is restricted, the fewer retrodirective antennas are used, the greater a communication area becomes.

The antenna selecting portion 130 may use the correlation characteristic between the number of selected retrodirective antennas and communication area of the retrodirective antennas, and may select the local area omnidirectional communication mode or the wide area directional communication mode to operate the retrodirective antennas.

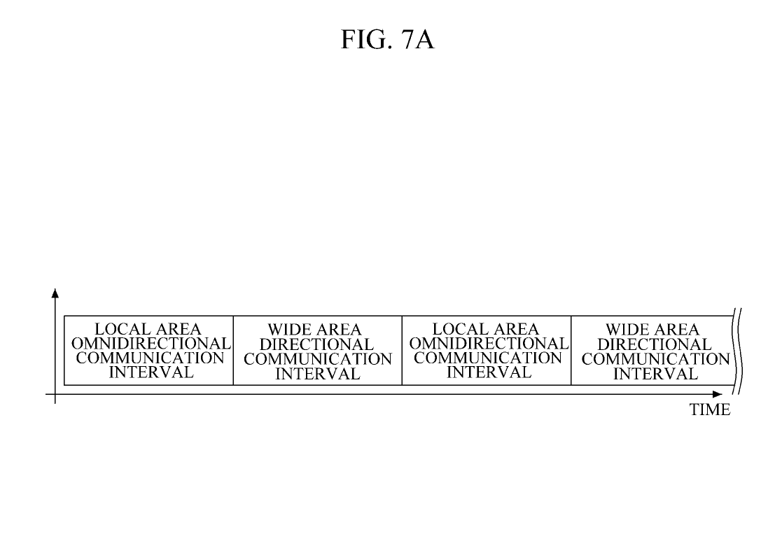

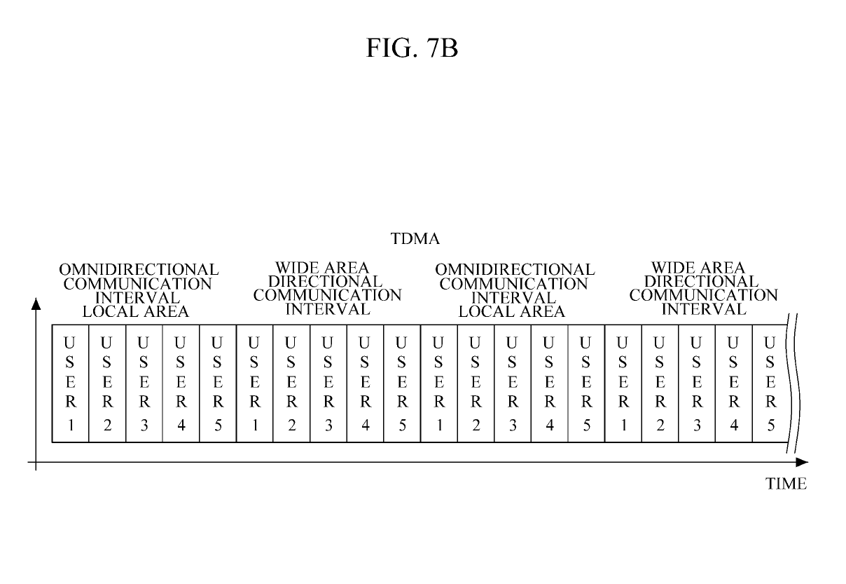

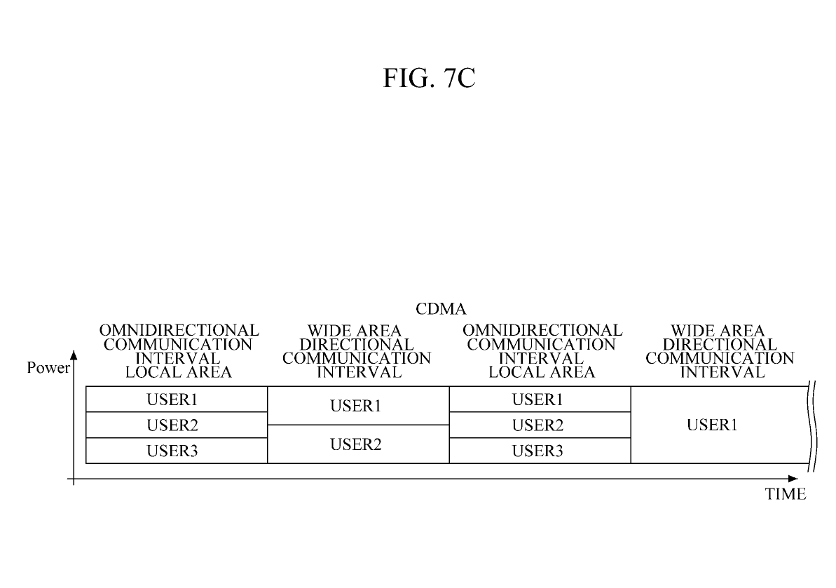

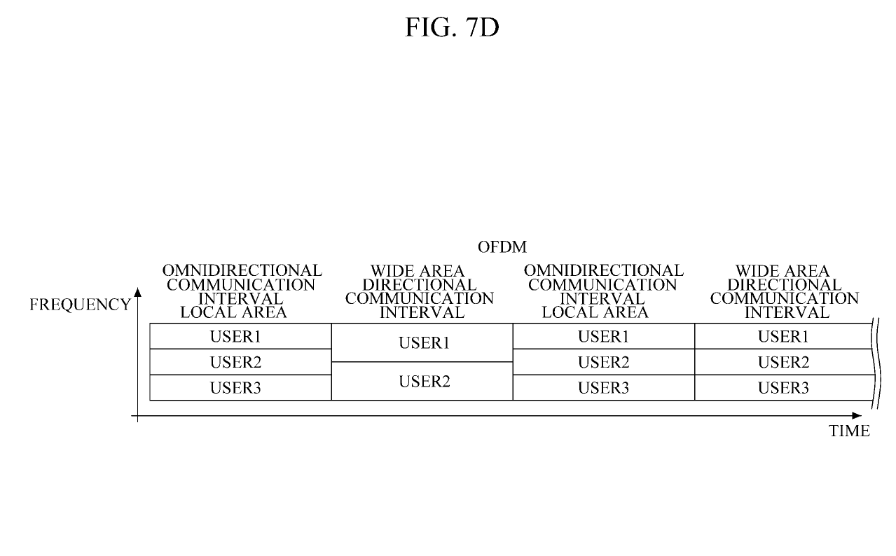

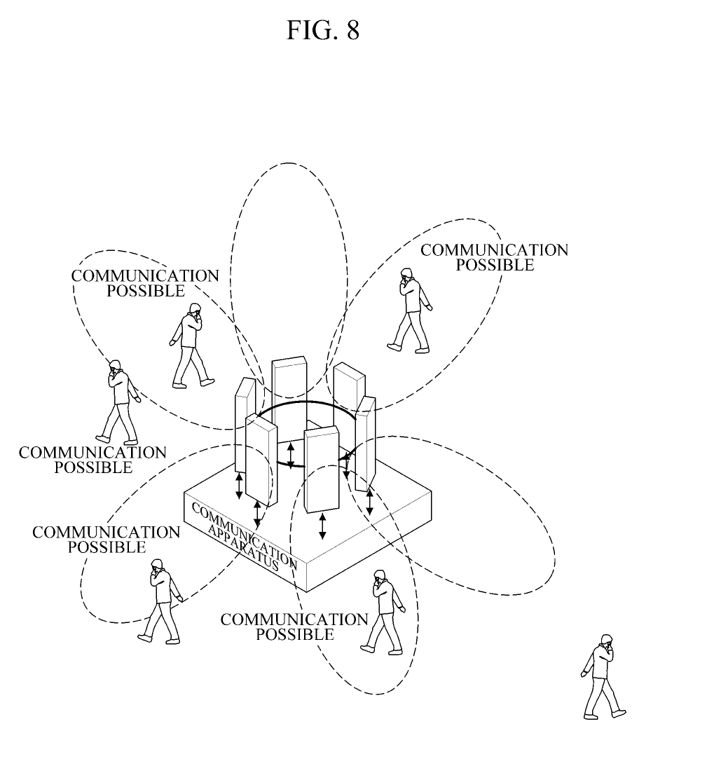

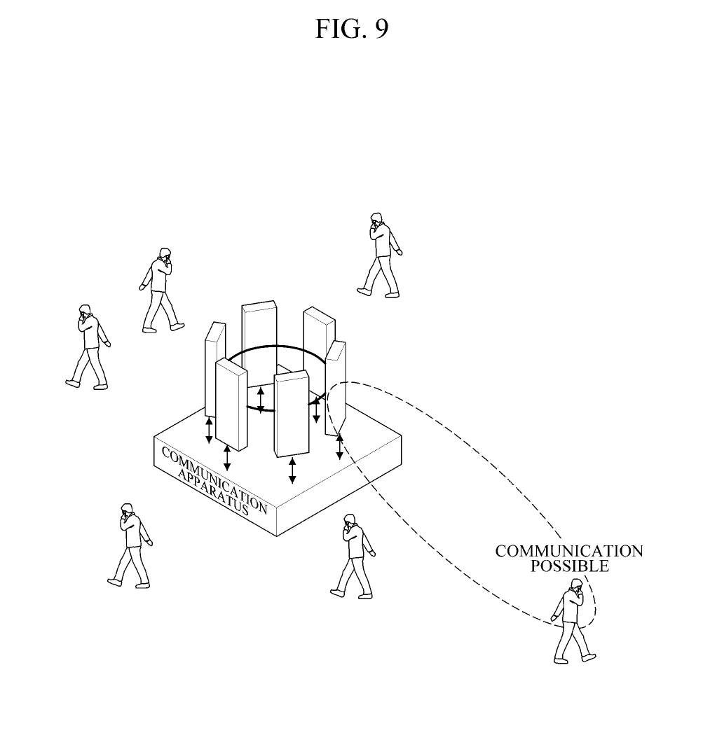

For example, as shown in FIGS. 7a to 7d, a communication time interval may be divided and every retrodirective antenna included in the antenna group 110 may be used. Further, as shown in FIG. 8, a local area omnidirectional communication interval (hereinafter, called a first time interval) for radiating a communication signal may be divided among a plurality of local area users, as shown in FIG. 9, and a wide area directional communication interval (hereinafter, called a second time interval) for transmitting the communication signal to a specific wide area user using one specific retrodirective antenna included in the antenna group 110.

FIG. 7b is a diagram showing user allocation in a case of dividing a communication interval into a local area omnidirectional communication interval and a wide area directional communication interval in a time division multiple access (TDMA) communication system. FIG. 7c is a diagram showing user allocation in a case of dividing a communication interval into a local area omnidirectional communication interval and a wide area directional communication interval in a code division multiple access (CDMA) communication system. FIG. 7d is a diagram showing user allocation in a case of dividing a communication interval into a local area omnidirectional communication interval and a wide area directional communication interval in an orthogonal frequency-division multiplexing (OFDM) communication system.

At this time, the first time interval, which is the local area omnidirectional communication interval, and the second time interval, which is the wide area directional communication interval, may repeatedly alternate. The first time interval, when affordable after allocating a resource among a plurality of local area users, may be allocated to wide area users. Accordingly, depending on a communication situation, the length of the first time interval may be adjustable.

Accordingly, by this implementation, the present invention may divide communication into an interval for omnidirectional communication with the local area users and an interval for directional communication with the specific wide area user, and operate the active retrodirective antennas. Therefore, it may extend the communication area by enabling communication with the wide area user, which is impossible with the omnidirectional antenna.

On the other hand, according to another embodiment of the inventive concept, the active retrodirective wireless communication apparatus 100 may further include a communication mode setting portion 140. The communication mode setting portion 140 may set the communication mode to the local area omnidirectional communication mode or the wide area directional communication mode. For example, the communication mode setting portion 140 may be implemented to set the communication mode to the local area omnidirectional communication mode during the first time interval and to the wide area directional communication mode during the second time interval. At this time, the first time interval and the second time interval may be set to repeatedly alternate.

The antenna selecting portion 130 may perform control for selecting the retrodirective antennas within the antenna group 110 depending on the local area omnidirectional communication mode or the wide area directional communication mode set by the communication mode setting portion 140, and operate the retrodirective antennas.

On the other hand, according to still another embodiment of the inventive concept, the active retrodirective wireless communication apparatus 100 may further include a user detecting portion 150. The user detecting portion 150, in the wide area directional communication mode, may detect a wide area directional communication user for each of the retrodirective antennas.

For example, the user detecting portion 150, in the wide area directional communication mode, may detect a user mobile terminal requesting communication via a specific retrodirective antenna. Accordingly, wide area directional communication user detection may be performed.

The antenna selecting portion 130, in the wide area directional communication mode, may select and operate the retrodirective antenna for which the wide area directional communication user is detected by the user detecting portion 150. Accordingly, wide area directional communication may be performed.

On the other hand, according to a still another embodiment of the inventive concept, the active retrodirective wireless communication apparatus 100 may further include a received signal strength (RSS) measuring portion 160, and a signal-to-noise ratio (SNR) measuring portion 170. The RSS measuring portion 160 may measure a received signal strength (RSS) of an RF signal which is incident upon each of the retrodirective antennas. The SNR measuring portion 170 may measure a signal-to-noise ratio (SNR) of the received RF signal.

The antenna selecting portion 130, in the local area omnidirectional communication mode, may consider the received signal strength (RSS) of the RF signal which is incident upon each of the retrodirective antennas measured by the RSS measuring portion 160, and the signal-to-noise ratio (SNR) of the RF signal measured by the SNR measuring portion 170, and select and operate at least two retrodirective antennas, thereby performing local area omnidirectional communication.

For example, the antenna selecting portion 130, in the local area omnidirectional communication mode, may be implemented to select at least two retrodirective antennas for which the SNR ratio of the RF signal is relatively small among retrodirective antennas for which the RSS of the RF signal is relatively large.

On the other hand, according to still another embodiment of the inventive concept, the active retrodirective wireless communication apparatus 100 may further include a phase-conjugate shifting portion 180. The phase-conjugate shifting portion 180 may phase-shift by 180 degrees and reradiate the phase of RF signal which is incident upon each of the plurality of the retrodirective antennas, and align a reflected wave main lobe with a direction of incidence. Since phase-conjugate shifting has been explained with reference to FIG. 1, it will not be described again here.

Further, according to still another embodiment of the inventive concept, the active retrodirective wireless communication apparatus 100 may further include an RF transmitting and receiving portion 190, which may transmit the RF signal to the phase-conjugate shifting portion 180 and receive the RF signal from the phase-conjugate shifting portion 180.

Accordingly, the RF signal transmitted and received through one or more of the retrodirective antennas selected by the antenna selecting portion 130 may have a retrodirective characteristic due to the phase-conjugate shifting portion 180, and communication may be performed by transmitting and receiving the RF signal through the RF transmitting and receiving portion 190.

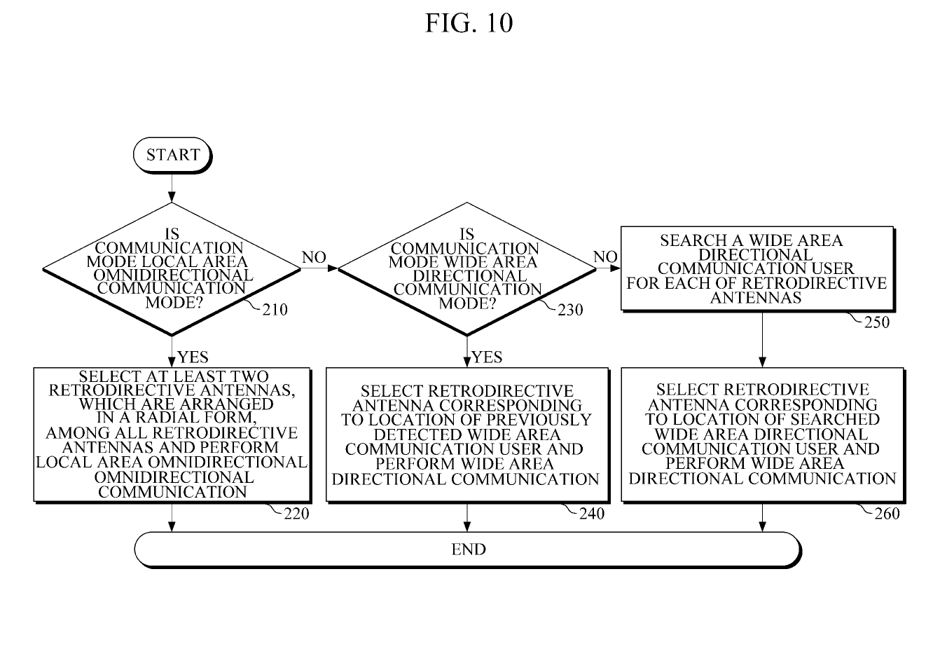

A communication operation of the active retrodirective wireless communication apparatus described above will be described below with reference to FIG. 10. FIG. 10 is a flowchart showing a communication operation of an active retrodirective wireless communication apparatus according to an embodiment of the inventive concept.

First, in an operation 210, the active retrodirective wireless communication apparatus may determine whether a communication mode is the local area omnidirectional communication mode.

If the active retrodirective wireless communication apparatus determines the communication mode to be the local area omnidirectional communication mode, in an operation 220, the active retrodirective may select at least two retrodirective antennas, which are arranged in a radial form, among all retrodirective antennas, and perform local area omnidirectional communication.

If the active retrodirective wireless communication apparatus determines the communication mode to be the wide area directional communication mode, in an operation 230, the active retrodirective wireless communication apparatus may determine whether a previously detected wide area directional communication user exists.

If the previously detected wide area directional communication user exists, in an operation 240, the active retrodirective wireless communication apparatus may select a retrodirective antenna corresponding to a location of the previously detected wide-area directional communication user, and perform wide area directional communication.

If the previously detected wide area directional communication user does not exist, in an operation 250, the active retrodirective wireless communication apparatus may search a wide area directional communication user for each of the retrodirective antennas.

In an operation 260, the active retrodirective wireless communication apparatus may select a retrodirective antenna corresponding to a location of a searched wide area directional communication user, and perform wide area directional communication.

According to the method described above, the active retrodirective wireless communication apparatus of the inventive concept may establish a time interval for performing omnidirectional communication among a plurality of local area users, and a time interval for performing directional communication with a specific wide area user. Accordingly, the active retrodirective wireless communication apparatus of the inventive concept is able to extend a communication area to enable communication with a wide area user who is not able to communicate via an omnidirectional antenna, thus achieving the purpose of the inventive concept.

The present invention can be implemented as computer-readable codes in a computer-readable recording medium. The computer-readable recording medium includes all types of recording media in which computer-readable data are stored. Examples of the computer-readable recording medium include a ROM, a RAM, a CD-ROM, a magnetic tape, a floppy disk, and an optical data storage. Further, the recording medium may be implemented in the form of carrier waves such as those used in Internet transmission. In addition, the computer-readable recording medium may be distributed to computer systems over a network, in which computer-readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An active retrodirective wireless communication apparatus, comprising:
an antenna group configured to include a plurality of retrodirective antennas arranged in a radial form, each of the plurality of retrodirective antennas having a specified azimuth and elevation;
an antenna switch configured to selectively switch at least two retrodirective antennas, which are arranged in a radial form, among the plurality of retrodirective antennas included in the antenna group during local area omnidirectional communication, and to selectively switch one specific retrodirective antenna among the plurality of the retrodirective antennas included in the antenna group during wide area directional communication; and
an antenna selecting portion configured to determine whether a communication mode is a local area omnidirection communication mode or a wide area directional communication mode, select one or more retrodirective antennas according to the determined communication mode, and transmit an antenna switching command instructing the selected one or more retrodirective antennas to switch to the antenna switch.

2. The apparatus according to claim 1, further comprising:
a communication mode setting portion configured to set the communication mode to the local area omnidirectional communication mode or the wide area directional communication mode.

3. The apparatus according to claim 2, wherein the communication mode setting portion sets the communication mode to the local area omnidirectional communication mode during a first time interval, and to the wide area directional communication mode during a second time interval.

4. The apparatus according to claim 3, wherein the first time interval and the second time interval repeatedly alternate.

5. The apparatus according to claim 1, further comprising:
a user detecting portion, in the wide area directional communication mode, configured to detect a wide area directional communication user for each of the plurality of the retrodirective antennas.

6. The apparatus according to claim 5, wherein the antenna selecting portion, in the wide area directional communication mode, selects the retrodirective antenna for which the wide area directional communication user is detected by the user detecting portion.

7. The apparatus according to claim 1, further comprising:
an RSS measuring portion configured to measure a received signal strength (RSS) of an RF signal which is incident upon each of the plurality of the retrodirective antennas; and
an SNR measuring portion configured to measure a signal-to-noise ratio (SNR) of the received RF signal.

8. The apparatus according to claim 7, wherein the antenna selecting portion, in the local area omnidirectional communication mode, considers the received signal strength (RSS) of the RF signal which is incident upon each of the plurality of the retrodirective antennas measured by the RSS measuring portion, and the signal-to-noise ratio of the RF signal measured by the SNR measuring portion, and selects at least two retrodirective antennas.

9. The apparatus according to claim 1, further comprising:
a phase-conjugate shifting portion configured to phase-shift by 180 degrees and reradiate the phase of RF signal which is incident upon each of the plurality of the retrodirective antennas, and align a reflected wave main lobe with a direction of incidence.

10. The apparatus according to claim 9, further comprising:
a transmitting and receiving portion configured to transmit the RF signal to the phase-conjugate shifting portion and to receive the RF signal from the phase-conjugate shifting portion.
